(19) United States
(12) Patent Application Publication
(10) Pub. No.: US 2014/0198210 A1
(43) Pub. Date: Jul. 17, 2014

(54) IMAGE MONITORING SYSTEM AND METHOD OF OPERATING THE SAME

(71) Applicant: SAMSUNG TECHWIN CO., LTD., Changwon-city (KR)

(72) Inventors: Youn LEE, Changwon-city (KR); Kyung Bok LEE, Changwon-city (KR)

(73) Assignee: SAMSUNG TECHWIN CO., LTD., Changwon-city (KR)

(21) Appl. No.: 14/132,245

(22) Filed: Dec. 18, 2013

(30) Foreign Application Priority Data
Jan. 11, 2013 (KR) 10-2013-0003506

(51) Int. Cl. H04N 7/18

(52) U.S. Cl. CPC H04N 7/183
USPC 348/143

(57) ABSTRACT

Provided is an image-monitoring system which includes a camera such as a pan/tilt/zoom camera which stores preset positions and captures images when a direction of the camera changes from one present position to another preset position, and a management unit which sets the preset positions, transmits the preset positions to the camera, and displays the images on a screen.

### CROSS REFERENCE TO RELATED APPLICATION

This application claims priority from Korean Patent Application No. 10-2013-0003506, filed on Jan. 11, 2013, in the Korean Intellectual Property Office, the disclosure of which is incorporated herein in its entirety by reference.

### BACKGROUND

1. Field

One or more embodiments of the inventive concept relate to an image monitoring system and method of operating the system that checks a preset image captured by a pan, tilt, and zoom (PTZ) camera.

2. Description of the Related Art

In a general image-monitoring system, a specific monitoring area is designed to include a maximum of 64 points, and the points are sequentially monitored based on one scenario. Generally, after an image is captured in one preset position in a monitoring area, the camera is directed to a next preset position at the highest speed to capture another image, and then the camera is directed to another preset position at the highest speed to capture another image, and so on. Each image captured at each preset position is sequentially displayed on a screen for a predetermined time. Hence, when a plurality of preset positions are set in the monitoring area, it takes a long time to check all images.

### SUMMARY

One or more embodiments of the inventive concept provide an image monitoring system and a method of operating the system to simultaneously check a plurality of images captured at preset positions within a limited time.

Various aspects will be apparent from the description, or may be learned by practice of the embodiments.

According to an aspect of an exemplary embodiment, there is provided an image monitoring system which may include: a camera which is configured to store predetermined preset positions and take an image when the camera is directed to each preset position; and a management unit which is configured to set the preset positions, transmit the preset positions to the camera, and display the images on a screen.

The camera may include at least one motor which changes a direction of the camera with respect to the predetermined preset positions.

The image monitoring system may further include a reduction unit which reduces an acceleration and deceleration load of the motor.

The reduction unit may operate when the motor changes a direction of the camera from one preset position to another preset position.

The reduction unit may include a low pass filter.

The image monitoring system may further include a vibration offset unit which offsets a vibration of the motor.

The vibration offset unit may generate a vibration having a phase frequency different from a phase frequency of a vibration of the motor.

The vibration offset unit may operate when the motor changes a direction of the camera from one preset position to another preset position.

The management unit may include: a preset position setting unit which sets one or more preset positions; a display unit which displays as many images as the number of predetermined preset positions, the images being received from the camera; and a controller which controls division of a display screen into as many areas as the number of the predetermined preset positions and displays the images captured by the camera at the predetermined preset positions on the divided display screen.

According to an aspect of another exemplary embodiment, there is provided a method of operating an image monitoring system which may include: setting preset positions and transmitting the preset positions to a camera; receiving images captured by the camera when the camera is directed to the preset positions; and displaying the received images on a screen.

The method may further include reducing an acceleration and deceleration load of at least one motor which changes a direction of the camera with respect to the preset positions.

The reducing may be performed when the motor changes the direction of the camera from one preset position to another preset position among the preset positions.

The reducing may include performing low pass filtering.

The method may further include offsetting a vibration of at least one motor which changed a direction of the camera with respect to the preset positions.

The offsetting may include generating and applying a vibration having a frequency phase different from a frequency phase of a vibration of the motor.

The offsetting may be performed when the motor changes the direction of the camera from one preset position to another preset position among the preset positions.

The displaying may include: dividing a display screen into as many areas as the number of the preset positions; and displaying images which are captured by the camera at the preset positions on the divided display screen.

### BRIEF DESCRIPTION OF THE DRAWINGS

These and/or other aspects will become apparent and more readily appreciated from the following description of the exemplary embodiments, taken in conjunction with the accompanying drawings, in which:

FIG. 1 is a block diagram illustrating a configuration of an image-monitoring system according to an exemplary embodiment;

FIGS. 2A and 2B are diagrams illustrating smoothing filtering in a camera acceleration and deceleration section of FIG. 1, according to an exemplary embodiment;

FIGS. 3A and 3B are diagrams illustrating vibration reduction of a camera of FIG. 1, according to an exemplary embodiment;

FIG. 4 is a conceptual diagram illustrating an operation of the image-monitoring system illustrated in FIG. 1, according to an exemplary embodiment;

FIG. 5 is a flowchart illustrating a method of operating the image-monitoring system of FIG. 1, according to an exemplary embodiment; and

FIG. 6 is a flowchart illustrating a method of operating the image-monitoring system of FIG. 1, according to another exemplary embodiment.

### DETAILED DESCRIPTION

Reference will now be made in detail to exemplary embodiments, which are illustrated in the accompanying drawings, wherein like reference numerals refer to the like elements throughout. In this regard, the embodiments may have different forms and should not be construed as being limited to the descriptions set forth herein. Accordingly, the embodiments are merely described below, by referring to the drawings, to explain aspects of the embodiments.

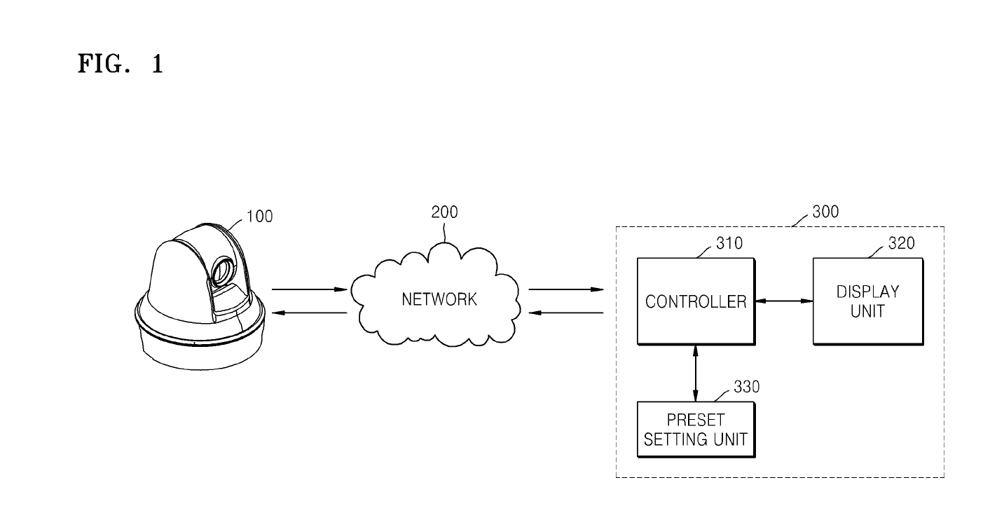

FIG. 1 is a block diagram illustrating a configuration of an image-monitoring system 10 according to an exemplary embodiment. Referring to FIG. 1, the image-monitoring system 10 includes a camera 100, a network 200, and a management unit 300.

The camera 100 is a pan/tilt/zoom (PTZ) camera which can move in vertical and horizontal directions between a −5° to 185° tilt angle and a 0° to 360° pan angle, and may monitor a desired place with a desired magnification. Hereinafter, the camera 100 will be referred to as the PTZ camera 100. The PTZ camera 100 may designate a plurality of monitoring areas to monitor, while existing monitoring cameras monitor only a fixed location. The PTZ camera 100 is connected to the management unit 300 through the network 200, and a monitoring operation is controlled via the management unit 300. Some examples of monitoring modes are a manual mode in which monitoring is performed by manually adjusting a position of the PTZ camera 100 using a joystick and a preset mode wherein the PTZ camera 100 is directed to monitoring positions which have been stored in advance by a user and corresponding areas are sequentially monitored at a predetermined time.

The PTZ camera 100 captures images of monitoring areas in a predetermined monitoring mode which is selected from the management unit 300. The PTZ camera 100 includes a pan motor (not shown) and a tilt motor (not shown). The pan motor may rotate the PTZ camera 100 between 0° and 360° degrees around a horizontal (x-axis) direction. Also, a stepping motor to change the rotation speed around the horizontal (x-axis) direction may be used. The tilt PTZ camera 100 may be rotated between −5° to 185° degrees around a vertical (y-axis) direction, and the stepping motor may be also used to change the rotation speed around the vertical (y-axis) direction.

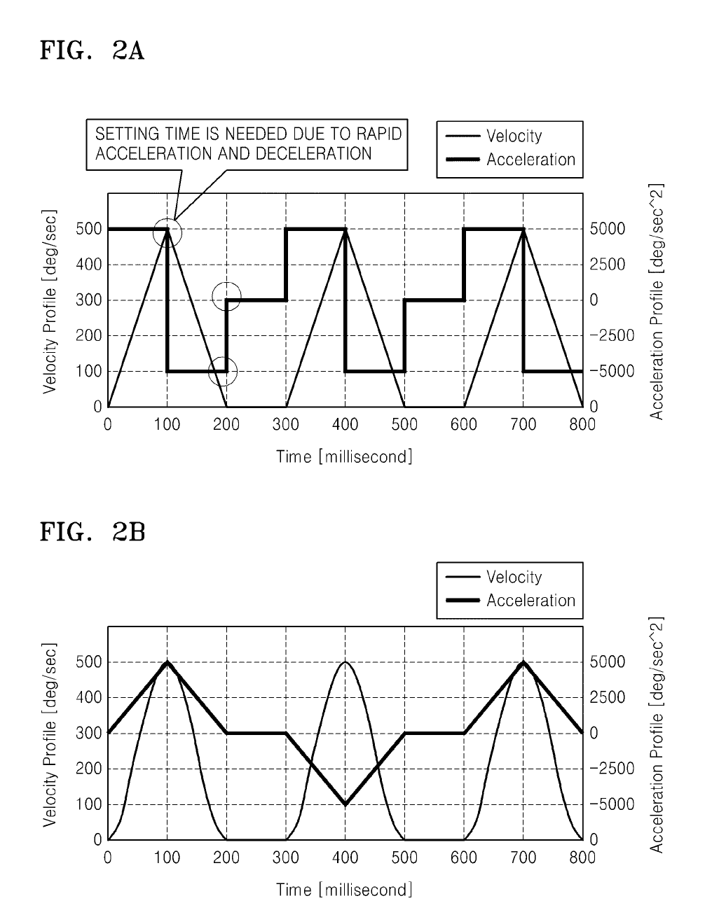

The pan/tilt (PT) motor operates at the highest speed within a short time to direct the PTZ camera 100 from a predetermined preset position 1 to a predetermined preset position 2 or vice versa. A motion speed profile of the PT motor may take a form as illustrated in FIG. 2A. An algorithm to generate the speed profile of this form is simple, but because acceleration and deceleration speed is high, a heavy load is applied to the PT motor in a short time. Hence, the load of the PT motor is gradually reduced by applying a smoothing filter such as a low pass filter. FIG. 2B illustrates a result of reducing a rapid acceleration and deceleration change section by applying low pass filtering to the speed profile of FIG. 2A. Such a smoothing filtering operation may be set to be performed in the PTZ camera 100 whenever the PT motor is operated to direct the PTZ camera 100 from one present position to another preset position.

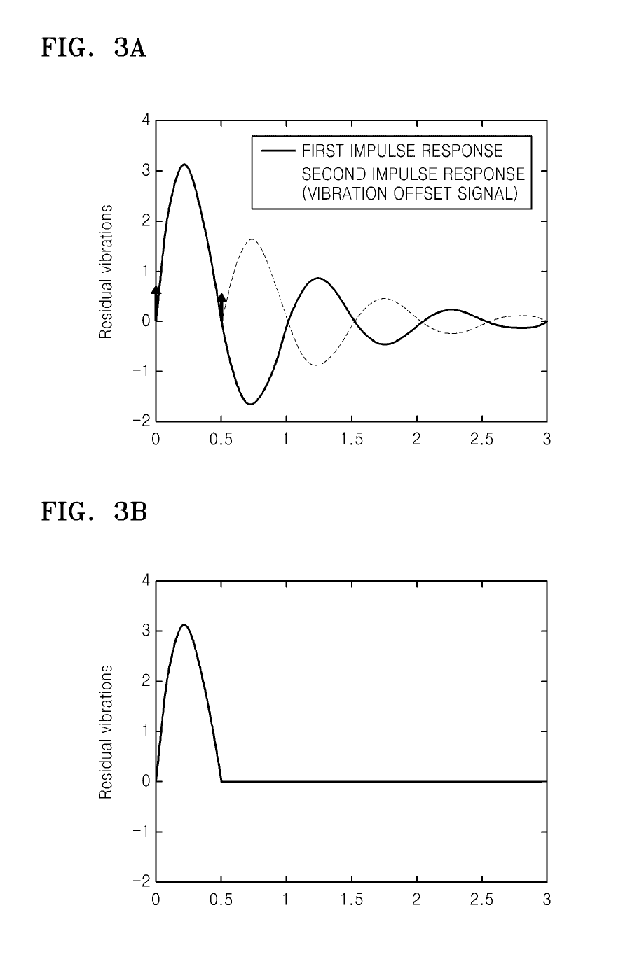

Furthermore, when a direction of the PTZ camera 100 is changed between preset position 1 and preset position 2, a residual vibration occurs in the PT motor, which affects performance of the PTZ camera 100. Hence, in order to remove the residual vibration, the PTZ camera 100 may offset the residual vibration by generating a vibration offset signal having a phase different from that of the residual vibration. In FIG. 3A, a first impulse response signal indicates a residual vibration which is generated in the PTZ camera 100. If a second impulse response signal is generated as a vibration offset signal to offset such residual vibration, the residual vibration may be offset as illustrated in FIG. 3B. Such vibration offset operation may be set to be performed in the PTZ camera 100 whenever the PT motor is operated to direct the PTZ camera 100 from one preset position to another preset position.

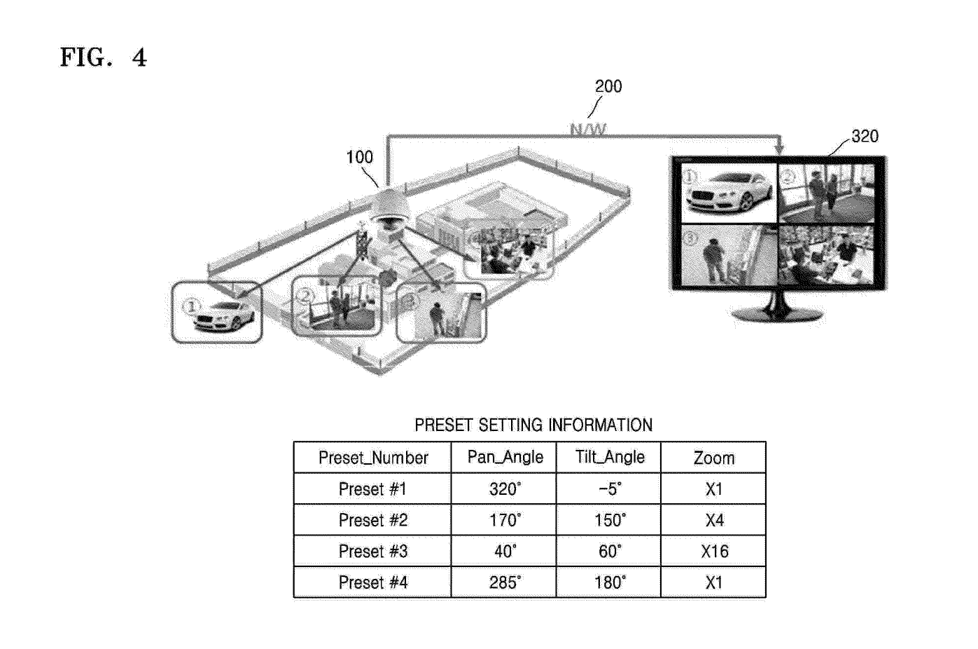

The management unit 300 displays an image transmitted from the PTZ camera 100 through the network 200 in a web page form, i.e., a web viewer form. The management unit 300 receives and displays an image which is captured by the PTZ camera at each preset position. In detail, the management unit 300 divides one screen into as many areas as the number of predetermined preset positions, receives images captured at the preset positions and displays the received images on the divided screen. Furthermore, the management unit 300 transmits the predetermined preset positions to the PTZ camera 100 through the network 200. The management unit 300 includes a controller 310, a display unit 320, and a preset position setting unit 330. Hereinafter, operations of the entire system will be described with reference to FIG. 4.

The web viewer, which is output to the display unit 320 by the controller 310, includes a function which may be preset. The preset position setting unit 330 sets at least one preset position so that the PTZ camera 100 may capture an image, and may also set a pan angle, a tilt angle, and a zoom magnification of the PTZ camera. In FIG. 4, the PTZ camera 100 changes its directions between preset positions 1 to 4, and thus, the preset position setting unit 330 may set four preset positions. However, the number of preset positions may change depending on the performance of the PTZ camera 100.

The controller 310 transmits a preset position set by the preset position setting unit 330 to the PTZ camera 100 through the network 200, and the PTZ camera 100 stores the transmitted preset position in an internal table. To capture a still image, the PT motor of the PTZ camera 100 is operated to direct the PTZ camera 100 to preset position 1 to capture a still image 1, and then transmits the still image 1 to the controller 310 through the network 200. Thereafter, the PT motor of the PTZ camera 100 is operated to direct the PTZ camera 100 to preset position 2 to capture a still image 2, and then transmits the still image 2 to the controller 310 through the network 200. Likewise, the PT motor is operated to direct the PTZ camera 100 to all predetermined preset positions to capture still images at the respective preset positions, and then transmits the still images to the controller 310.

The controller 310 collects the still images captured at the respective preset positions by the PTZ camera 100, and displays the collected still images. In detail, the controller 310 may divide the screen of the display unit 320 into as many areas as the number of predetermined preset positions, and may display the still images on the divided screen. The still images are displayed for a predetermined time, and after the predetermined time passes, the controller 310 collects again still images captured at the respective preset positions again by the PTZ camera 100, and the collected still images are displayed again on the divided screen. Hence, a plurality of preset images may be simultaneously checked within a limited time, thereby improving the user convenience.

It was illustrated in the present embodiment that still images, which have been captured after a direction of the PTZ camera 100 is changed to the predetermined preset positions, are collected and the collected still images are displayed on the divided screen. However, still images may be captured in the pan/tilt movement section by adjusting the shutter speed and these still images may be displayed.

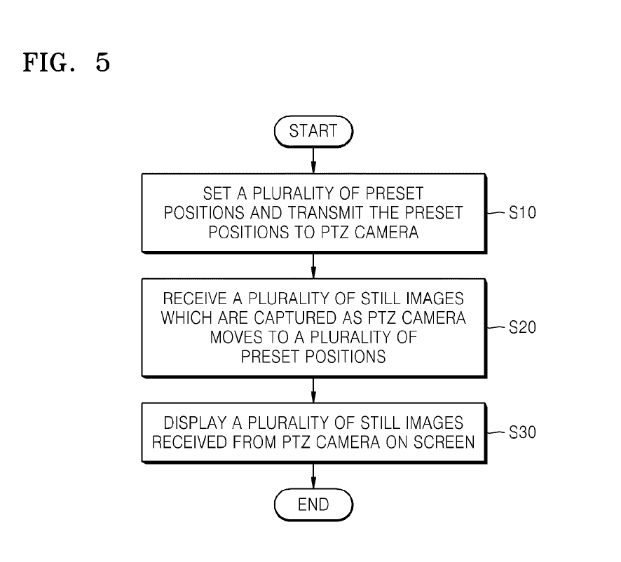

FIG. 5 is a flowchart illustrating a method of operating the image-monitoring system 10 according to an exemplary embodiment. In the description below, the descriptions of elements described with reference to FIGS. 1 to 4 will be omitted.

Referring to FIG. 5, the management unit 300 sets a plurality of preset positions, and performs an operation of transmitting the preset positions to the PTZ camera 100 through the network 200 (S10).

A user may set a plurality of preset positions through the web viewer screen on the display unit 320. The pan angle, the tilt angle, and the zoom magnification of the PTZ camera 100 may be also set at the time of setting the preset positions. When the display unit 320 is a touch screen, the present positions may be set by touching the screen, and when the display unit 320 is a common monitor, the preset positions may be set by using an input device such as a mouse, an electric pen, a keyboard, etc.

The PTZ camera 100 receives a preset setting signal, stores the preset setting signal in an internal table, changes its direction to respective stored preset positions to capture still images, and transmits the still images to the management unit 300 (S20).

The PTZ camera 100 performs a smoothing filtering operation to reduce the acceleration and deceleration load of the PT motor which is generated when the direction of the PTZ camera is changed from a current preset position to a next preset position, and generates a vibration offset signal for vibration offset.

The management unit 300 displays a plurality of still images received from the PTZ camera 100 (S30).

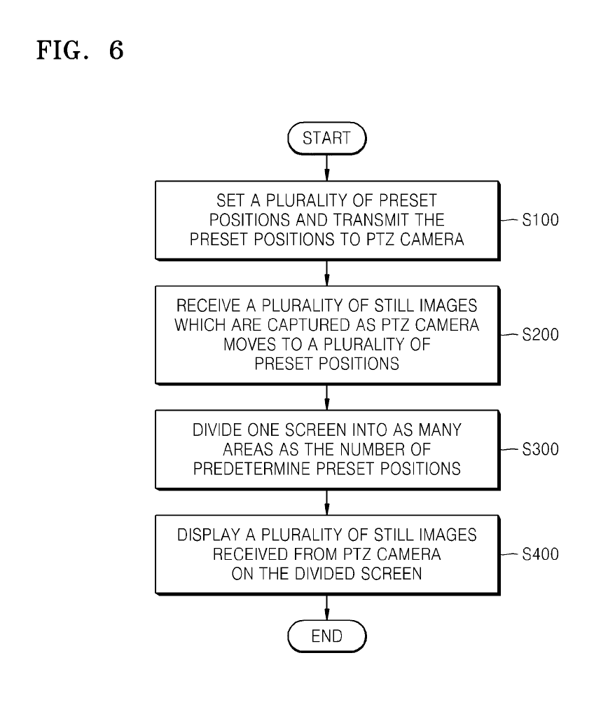

FIG. 6 is a flowchart illustrating a method of operating the image-monitoring system 10 according to another exemplary embodiment. In the description below, the descriptions of elements described with reference to FIGS. 1 to 5 will be omitted.

Referring to FIG. 6, the management unit 300 sets a plurality of preset positions, and transmits the preset positions to the PTZ camera 100 through the network 200 (S100).

The PTZ camera 100 receives a preset setting signal, stores the preset setting signal in the internal table, changes its direction to respective stored preset positions to capture still images, and transmits the still images to the management unit 300 (S200).

The management unit 300 divides the screen into as many areas as the number of predetermined preset positions (S300).

After the screen division is completed, the management unit 300 collects a plurality of still images transmitted from the PTZ camera 100, and displays the collected still images on the divided screen (S400).

Meanwhile, the methods illustrated in FIGS. 5 and 6 can be realized as a computer executable program code, stored in various a non-transitory computer readable medium, and executed by a processor.

A non-transitory computer readable medium indicates a medium which semi-permanently stores data and is readable with a device, different from a medium which stores data for a short time such as register, cache, memory, etc.

Also, the block diagrams in FIGS. 1, 5 and 6 illustrate apparatuses or methods according to the exemplary embodiments. In this regard, each block may represent a module, a program, or a part of code, which contains one or more executable instructions for performing specified logic functions. It should also be noted that block diagrams may be implemented by a dedicated hardware-based system for performing specified functions or operations, by a software-based system for performing specified functions or operations, or by a combination of dedicated hardware and computer instructions.

As described above, according to the one or more of the above embodiments, respective images captured by a camera as the camera moves to a plurality of preset positions are simultaneously displayed on one screen, and thus, a plurality of still images may be simultaneously checked within a limited time, thereby improving the user convenience.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

What is claimed is:

1. An image monitoring system comprising:
a camera which is configured to store predetermined preset positions and capture an image when the camera is directed to each preset position; and
a management unit which is configured to set the preset positions, transmit the preset positions to the camera, and display the images on a screen.

2. The image monitoring system of claim 1, wherein the camera comprises:
at least one motor which is configured to change a direction of the camera with respect to the predetermined preset positions.

3. The image monitoring system of claim 2, further comprising:
a reduction unit which is configured to reduce an acceleration and deceleration load of the motor.

4. The image monitoring system of claim 3, wherein the reduction unit is configured to operate when at least one of the motor changes the direction of the camera from one preset position to another preset position among the predetermined preset positions.

5. The image monitory system of claim 4, wherein the motor comprises a pan motor and a tilt motor.

6. The image monitoring system of claim 3, wherein the reduction unit comprises a low pass filter.

7. The image monitoring system of claim 2, further comprising:
a vibration offset unit which is configured to offset a vibration of the motor.

8. The image monitoring system of claim 7, where the vibration offset unit is configured to generate a vibration having a phase frequency different from a phase frequency of a vibration of the motor.

9. The image monitoring system of claim 8, wherein the vibration offset unit is configured to operate when the pan changes a direction of the camera from one preset position to another preset position among the predetermined preset positions.

10. The image monitoring system of claim 1, wherein the management unit comprises:
a preset position setting unit which is configured to set one or more preset positions;
a display unit which is configured to display as many images as the number of predetermined preset positions, the images being received from the camera; and
a controller which is configured to control division of a display screen into as many areas as the number of the predetermined preset positions and display the images captured by the camera at the predetermined preset positions on the divided display screen.

11. The image monitoring system of claim 10, wherein the camera is a pan/tilt/zoom camera.

12. A method of operating an image monitoring system, the method comprising:
setting preset positions and transmitting the preset positions to a camera;
receiving images captured by the camera when the camera is directed to the preset positions; and
displaying the received images on a screen.

13. The method of claim 12, further comprising:
reducing an acceleration and deceleration load of at least one motor which changes a direction of the camera with respect to the preset positions.

14. The method of claim 13, wherein the reducing is performed when the motor changes the direction of the camera from one preset position to another preset position among the preset positions.

15. The method of claim 13, wherein the reducing comprises:
performing low pass filtering.

16. The method of claim 12, further comprising:
offsetting a vibration of at least one motor which changed a direction of the camera with respect to the preset positions.

17. The method of claim 16, wherein the offsetting comprises:
generating and applying a vibration having a frequency phase different from a frequency phase of a vibration of the motor.

18. The method of claim 16, wherein the offsetting is performed when the motor changes the direction of the camera from one preset position to another preset position among the preset positions.

19. The method of claim 12, wherein the displaying comprises:
dividing a display screen into as many areas as the number of the preset positions; and
displaying images which are captured by the camera at the preset positions on the divided display screen.

20. The method of claim 19, wherein the camera is a pan/tilt/zoom camera
